(19) United States
(12) Patent Application Publication
(10) Pub. No.: US 2017/0124576 A1
(43) Pub. Date: May 4, 2017

(54) SYSTEMS, PROCESSES, AND METHODS FOR ESTIMATING SALES VALUES

(71) Applicant: Fuelcomm Inc., Seattle, WA (US)

(72) Inventors: Michael Austin Lagoni, Seattle, WA (US); Michael Mugambi Masaki, Seattle, WA (US); Mitchell Strauss Keidan, Seattle, WA (US); Sean William Kelley, Seattle, WA (US)

(21) Appl. No.: 15/337,815

(22) Filed: Oct. 28, 2016

Related U.S. Application Data
(60) Provisional application No. 62/270,466, filed on Dec. 21, 2015.
(60) Provisional application No. 62/247,909, filed on Oct. 29, 2015.

(51) Int. Cl. G06Q 30/02; H04L 29/08; G06F 17/30

(52) U.S. Cl. CPC G06Q 30/0201; G06F 17/3053; H04L 67/02; G06Q 30/0282

(57) ABSTRACT

Methods and systems for estimating sales values are provided. A computer system is used to receive product data for a plurality of products in a market. The product data can be obtained from one or more product pages accessed over a computer network. The product data is used to generate input variables, which can be used to generate analysis variables for the market. Analysis variables correlated to sales values can be determined by fitting to measured market data, and the identified analysis variables can be used to generate estimates of sales values, including estimates of sales values other than those for which market data was measured.

### CROSS-REFERENCE

This application claims the benefit of U.S. Provisional Application No. 62/247,909, filed Oct. 29, 2015, and U.S. Provisional Application No. 62/270,466, filed Dec. 21, 2015, the entire contents of which are incorporated herein by reference.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BACKGROUND OF THE INVENTION

Businesses can benefit from access to comprehensive sales information from the e-commerce channel, as well as a single repository for all online retail sales. An available data source that contains estimated sales values for every retailer, product category, brand, and product that is available for any individual or business to use can also be highly valuable.

### SUMMARY OF THE INVENTION

Provided herein are methods of estimating sales values. The methods can comprise: obtaining, with a computer, content from product pages for products in at least one online catalog and generating, with the computer, a graph comprising a plurality of vertices and a plurality of edges. Each vertex in the plurality of vertices corresponds to a product, and each edge in the plurality of edges connects a pair of vertices. The edges are determined by the content obtained from the product pages corresponding to one or more of the pair of vertices. A market is determined with the computer; the market is derived from the graph, and the market comprises a plurality of products. The computer assigns to each input variable of a plurality of input variables a corresponding value for each product in the market, wherein the corresponding value is derived from the content obtained from the product pages. The computer further defines a plurality of analysis variables derived from the input variables, wherein the analysis variables have a value derived from the input variables for each product in the market. The computer assigns weights to each analysis variable in the plurality of analysis variables, and generates an estimate of a sales value for at least one product in the market, wherein the estimate is determined from a weighted sum of the analysis variables. Information representing that estimate is recorded to a computer-readable medium.

In some embodiments, the step of generating an estimate of a sales value is performed for every product in the market. A total market size for the sales value can be estimated.

In some embodiments, the product pages are obtained from a website. In some embodiments, the product pages are obtained from an API. In some embodiments, the product pages are obtained from a database.

In some embodiments, each input variable in the plurality of input variables is assigned a value for each of a plurality of times within a specified time frame.

In some embodiments, the weights are assigned to each analysis variable based on a fit of each analysis variable to input data for at least one product in the market, wherein the input data for the at least one product comprises past estimates of sales values, user-supplied measures of sales values, or a combination of the two.

In some embodiments, the estimate of the sales value corresponds to a specified period of time. The sales value can be product market share, product revenue, or product sales volume. In some aspects, the sales value can be a number of customers buying the product, an average order value for a product, or a number of refunds for a product.

Some embodiments further comprise the step of sorting the plurality of products in the market according to the respective value assigned to the at least one product for an analysis variable.

In some embodiments, the content of the plurality of product pages is obtained by: entering into a website or API a search term related to a market of interest; appending a plurality of product pages generated in response to the search to a list of pages to visit; visiting a page on the list of pages to visit that has not yet been visited; parsing the page to obtain content therefrom; identifying, from the parsed content, one or more linked product pages; adding to the list of pages to visit each linked product page identified that has not already been added; and repeating the steps of visiting, parsing, identifying, and adding until either reaching a predetermined threshold of visited pages or determining that each product page on the list of pages to visit has been visited.

In some embodiments, one or more of the plurality of input variables comprise a product price, a product ranking by retailers, a number of customer reviews for products, a score from a product search query ranking order, or a score based on the number of products identifying each product as related or recommended.

In some embodiments, a first input variable of the plurality of input variables has a value for each product derived from the graph, and wherein each edge of the graph leading from a first product to a second product corresponds to a listing of the second product as a related or recommend product on a product page of the first product. In some aspects, the value of the first input variable for each product can be equal to the number of edges in the graph leading to that product. In some aspects, the value of the first input variable for each product is equal to a score determined by: assigning to each product an initial score; and updating the score of each product according to the scores of each other product with an edge leading thereto. The updating step can be repeated a fixed number of times, or until the score for each product changes less than a predetermined threshold in a given iteration. In some embodiments, at least one analysis variables is equal to said first input variable.

In some embodiments, at least one analysis variable is equal to at least one input variable. In some embodiments, at least one analysis variable is equal to a product of at least two input variables. In some embodiments, at least one analysis variable is equal to the product of at least one input variable and a constant. In some embodiments, an analysis variable comprises a multiplier chosen such that the sum of the values of the analysis variable for each product in the market is 1.

In some embodiments, the plurality of analysis variables are derived from the input variables by: initializing a set of analysis variables containing each input variable of the plurality of input variables; selecting an operator from a set of operators, the operator having one or more inputs; creating a new analysis variable by selecting, for each input of the operator, a previous analysis variable in the set of analysis variables; adding the new analysis variable to the set of analysis variables; and repeating the steps of selecting an operator, creating a new analysis variable, and adding the new analysis variable to the set of analysis variables until the size of the number of analysis variables in the set of analysis variables reaches a predetermined threshold. In some aspects further steps include identifying, from a plurality of analysis variables previously used to fit sales data, one or more previously used analysis variables to which highest weights were assigned, and adding the one or more previously used analysis variables to the set of analysis variables.

In some aspects, the selected operator of at least one repetition is a multiplication operator, a constant multiplier, an addition operator, an exponential operator, a division operator, or a time derivative operator.

In some embodiments, at least one analysis variables is derived from a combination of input variables including a total quantity of reviews, a net increase in reviews over the identified time period, and a product rating score. In some embodiments, at least one analysis variables is derived from a combination of input variables including a frequency of product appearance for keyword searches and a rank position of products in response to keyword searches.

In another aspect, provided herein is a system for estimating sales values. The system comprises a processor coupled to a computer network and a computer-readable storage medium. The system further comprises non-transient computer-readable memory coupled to the processor, the memory comprising instructions that, when executed, cause the system to: obtain content from product pages for products in at least one online catalog; generate a graph comprising a plurality of vertices and a plurality of edges, wherein each vertex in the plurality of vertices corresponds to a product, wherein each edge in the plurality of edges connects a pair of vertices, and wherein the edges are determined by the content obtained from the product pages corresponding to one or more of the pair of vertices; determine a market derived from the graph, wherein the market comprises a plurality of products; assign to each input variable of a plurality of input variables a corresponding value for each product in the market, wherein the corresponding value is derived from the content obtained from the product pages; define a plurality of analysis variables derived from the input variables, wherein the analysis variables have a value derived from the input variables for each product in the market; assign weights to each analysis variable in the plurality of analysis variables; generate an estimate of a sales value for at least one product in the market, wherein the estimate is determined from a weighted sum of the analysis variables; and record information representing the estimate to the computer-readable storage medium.

In some embodiments, the instructions include a step of generating an estimate of a sales value for every product in the market. A total market size for the sales value can be estimated.

In some embodiments, the product pages are obtained from a website. In some embodiments, the product pages are obtained from an API. In some embodiments, the product pages are obtained from a database.

In some embodiments, each input variable in the plurality of input variables is assigned a value for each of a plurality of times within a specified time frame.

In some embodiments, the weights are assigned to each analysis variable based on a fit of each analysis variable to input data for at least one product in the market, wherein the input data for the at least one product comprises past estimates of sales values, user-supplied measures of sales values, or a combination of the two.

In some embodiments, the estimate of the sales value corresponds to a specified period of time. The sales value can be product market share, product revenue, or product sales volume. In some aspects, the sales value can be a number of customers buying the product, an average order value for a product, or a number of refunds for a product.

Some embodiments further comprise instructions to perform a step of sorting the plurality of products in the market according to the respective value assigned to the at least one product for an analysis variable.

In some embodiments, the content of the plurality of product pages is obtained by: entering into a website or API a search term related to a market of interest; appending a plurality of product pages generated in response to the search to a list of pages to visit; visiting a page on the list of pages to visit that has not yet been visited; parsing the page to obtain content therefrom; identifying, from the parsed content, one or more linked product pages; adding to the list of pages to visit each linked product page identified that has not already been added; and repeating the steps of visiting, parsing, identifying, and adding until either reaching a predetermined threshold of visited pages or determining that each product page on the list of pages to visit has been visited.

In some embodiments, one or more of the plurality of input variables comprise a product price, a product ranking by retailers, a number of customer reviews for products, a score from a product search query ranking order, or a score based on the number of products identifying each product as related or recommended.

In some embodiments, a first input variable of the plurality of input variables has a value for each product derived from the graph, and wherein each edge of the graph leading from a first product to a second product corresponds to a listing of the second product as a related or recommend product on a product page of the first product. In some aspects, the value of the first input variable for each product can be equal to the number of edges in the graph leading to that product. In some aspects, the value of the first input variable for each product is equal to a score determined by: assigning to each product an initial score; and updating the score of each product according to the scores of each other product with an edge leading thereto. The updating step can be repeated a fixed number of times, or until the score for each product changes less than a predetermined threshold in a given iteration. In some embodiments, at least one analysis variables is equal to said first input variable.

In some embodiments, at least one analysis variable is equal to at least one input variable. In some embodiments, at least one analysis variable is equal to a product of at least two input variables. In some embodiments, at least one analysis variable is equal to the product of at least one input variable and a constant. In some embodiments, an analysis variable comprises a multiplier chosen such that the sum of the values of the analysis variable for each product in the market is 1.

In some embodiments, the plurality of analysis variables are derived from the input variables by: initializing a set of analysis variables containing each input variable of the plurality of input variables; selecting an operator from a set of operators, the operator having one or more inputs; creating a new analysis variable by selecting, for each input of the operator, a previous analysis variable in the set of analysis variables; adding the new analysis variable to the set of analysis variables; and repeating the steps of selecting an operator, creating a new analysis variable, and adding the new analysis variable to the set of analysis variables until the size of the number of analysis variables in the set of analysis variables reaches a predetermined threshold. In some aspects further steps include identifying, from a plurality of analysis variables previously used to fit sales data, one or more previously used analysis variables to which highest weights were assigned, and adding the one or more previously used analysis variables to the set of analysis variables.

In some aspects, the selected operator of at least one repetition is a multiplication operator, a constant multiplier, an addition operator, an exponential operator, a division operator, or a time derivative operator.

In some embodiments, at least one analysis variables is derived from a combination of input variables including a total quantity of reviews, a net increase in reviews over the identified time period, and a product rating score. In some embodiments, at least one analysis variables is derived from a combination of input variables including a frequency of product appearance for keyword searches and a rank position of products in response to keyword searches.

Aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1A illustrates an exemplary system architecture for estimating sales values, in accordance with embodiments;

FIG. 1B illustrates an exemplary product web page hosted on an electronic commerce web site accessible by a sales estimation system;

FIG. 2 illustrates an exemplary process of generating sales estimates for one or more products in an online marketplace, in accordance with embodiments;

FIG. 3 illustrates an exemplary computer system configured to perform the functions of systems and methods described herein, in accordance with embodiments.

### DETAILED DESCRIPTION OF THE INVENTION

In some embodiments, the electronic commerce estimation systems, methods, and processes described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and uses power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (PRAM). In some embodiments, the nonvolatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, the electronic commerce estimation systems disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services. In some aspects, the program and instructions are permanently, substantially permanently, semi-permanently, or non-transitorily encoded on the media.

In some embodiments, the electronic commerce estimation systems disclosed herein include at least one computer program, or use of the same. A computer program includes a sequence of instructions, executable in the digital processing device's CPU, written to perform a specified task. Computer readable instructions can be implemented as program modules, such as functions, objects, Application Programming Interfaces (APis), and data structures that perform particular tasks or implement particular abstract data types. In light of the disclosure provided herein, those of skill in the art will recognize that a computer program can be written in various versions of various languages.

The functionality of the computer readable instructions can be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

In some embodiments, the electronic commerce estimation systems disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

In some embodiments, the electronic commerce estimation systems disclosed herein include one or more databases, or use of the same. In view of the disclosure provided herein, those of skill in the art will recognize that many databases are suitable for storage and retrieval of information as described herein. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

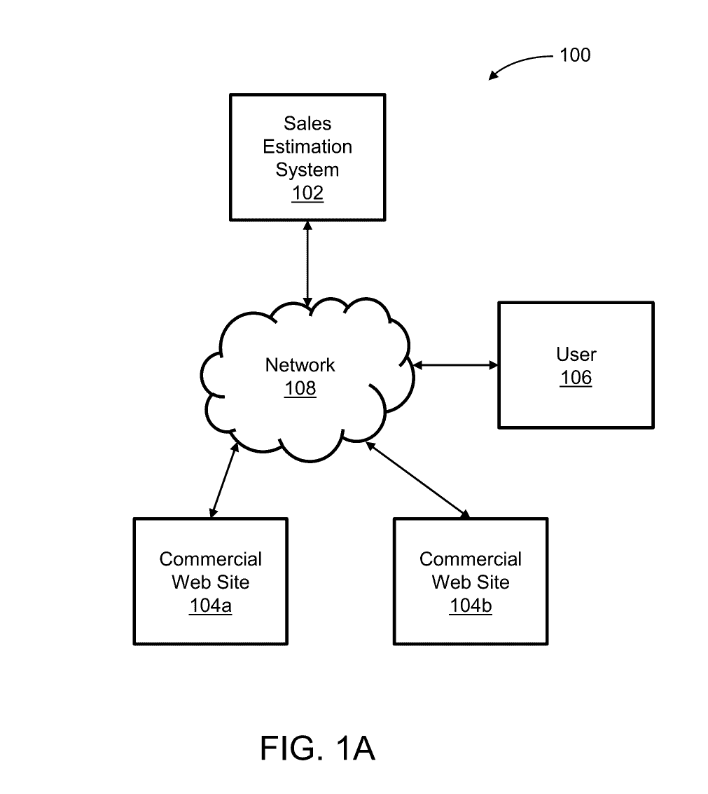

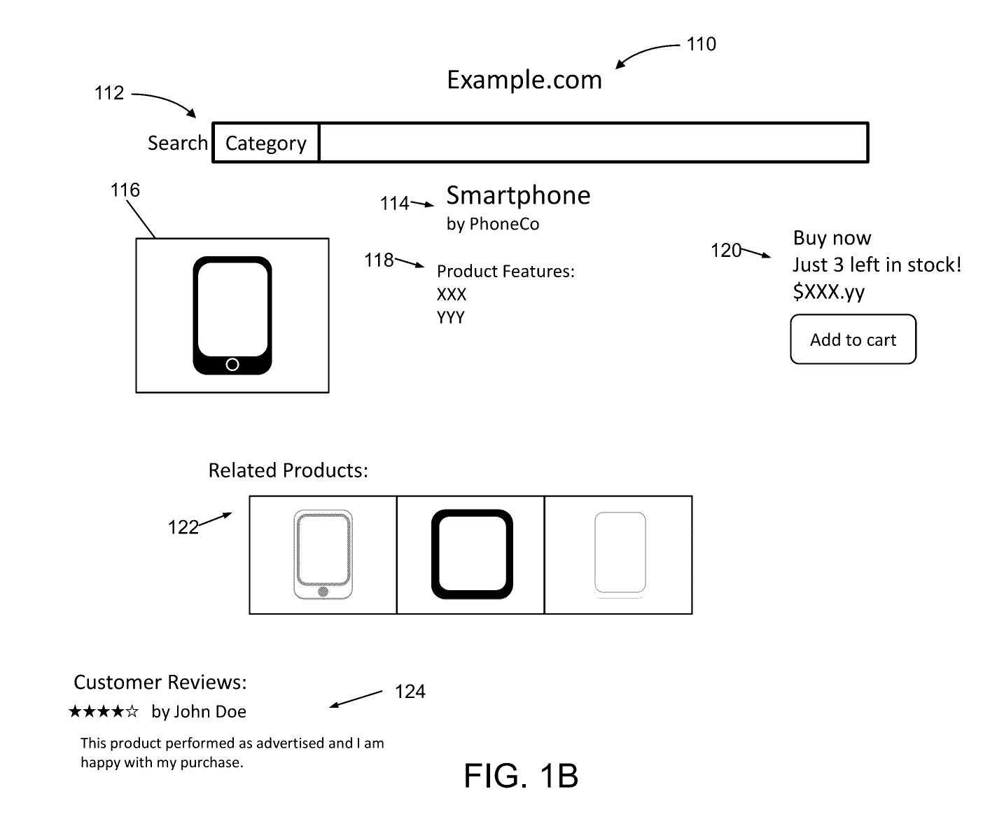

FIG. 1A illustrates a system architecture for estimating sales values, in accordance with embodiments. The system architecture 100 can include a sales estimation system 102, a plurality of electronic commerce websites or APIs 104a and 104b, and one or more users 106, connected to each other via a network 108. The sales estimation system 102 can include a server (also referred to herein as a “computer system” or “computing system”) configured to implement the various methods described herein. The server can include one or more of the digital processing devices or components thereof, as described further herein. For example, the server can include a central processing unit (CPU, also “processor” and “computer processor” herein), which can be a single core or multi core processor, or a plurality of processors for parallel processing. The server can also include memory (e.g., random-access memory, read-only memory, flash memory), data storage devices (e.g., hard disks), communications interfaces (e.g., network adapters) for communicating with one or more other systems and/or devices, and/or peripheral devices (e.g., cache, other memory, data storage and/or electronic display adapters). The memory can include instructions executable by the one or more processors of the transaction management system 102 to perform the methods described herein. A database can be provided to allow the storage and analysis of large volumes of data. In some embodiments, the sales estimation system 102 is implemented as a distributed “cloud” computing system across any suitable combination of hardware and/or virtual computing resources.

The sales estimation system 102 can be configured to access a plurality of electronic commerce websites 104a and 104b, each of which can be hosted on a web server. Alternatively or additionally, the system can access product catalogs from online merchants using other sources, such as APIs. The sales estimation system 102 can access a plurality of product pages on each electronic commerce website or API in order to obtain information related to the listed product. In many aspects, a product page will comprise content relating a listed product to other products offered by the electronic commerce website or the catalog accessed by the API; for example, the product page can comprise advertisements, links to related products, and customer feedback such as reviews or “likes.” The sales estimation system 102 can download such product page content from each product page, process it, and store information representative of the content in a storage system such as a database for use in sales estimation.

One or more users 106 can also connect to the sales estimation system 102 using network 108. At a user's request, the sales estimation system 102 can provide estimates of sales information related to one or more products. The estimates can be generated, for example, based on the information derived from product web pages of the electronic commerce websites or APIs 104a and 104b, which can be analyzed using methods as described herein. Summaries of this data can be provided, for example, in the form of graphs or numerical estimates, or as a full set of representative data. The users can be marketplace participants, and they can provide sales figures for one or more products to the sales estimation system 102. The sales estimation system 102 can use these sales figures to improve the accuracy, consistency, and reliability of its estimates, thereby providing more accurate market estimates not only to the user providing the figures, but also to other users in the same market or a related market that can desire access to the information. In some aspects, calibration based on sales figures can even improve estimates for products in significantly different markets.

FIG. 1B illustrates an exemplary product web page 110 hosted on an electronic commerce web site accessible by sales estimation system 102. The product web page comprises a search bar 112 into which search terms can be input, and can include a category field to narrow a search to items in a particular category. A list of product pages to search can initially be generated by performing a search based on keywords; for example, a search for “smartphone” can generate a list of candidate product pages for smartphones. Each such generated page can be accessed and analyzed by sales estimation system 102 to generate product data, as well as to determine related products in the same market based on the information, such as hyperlinks, on each product page. Typically, product web pages will be generated in an automated manner by the hosting site based on a template that fills in each page element in a systematic manner; for this reason, it can be straightforward to automatically extract this information upon loading the web page. For example, the source code used to compile the page can be programmatically parsed by sales estimation system 102 to extract each of the input variables disclosed herein.

Certain example data visible on a typical product web page are illustrated in FIG. 1B. Each of the illustrated data can be parsed and used as an input variable by sales estimation system 102. For example, the product name and brand 114, an image of the product 116, and product description 118 can be obtained. Pricing and availability data 120 can also be obtained. A list of related products can be accessed, and such a list can include links to other product pages. By recording each of the outgoing links on a product page, then visiting each of the linked pages and repeating this analysis, a graph can be generated showing the relationships amongst the various products within a given market. Further data can be obtained from customer feedback 124, including a count of the number of reviews, number of likes or dislikes, average reviewer rating, properties of the feedback text such as amount written and use of keywords.

In addition to the specific examples detailed above, many further types of product information can be obtained from sources such as product web pages, each of which can serve as an independent input variable to be parsed, stored, and used in analysis by sales estimation systems. Input variables that can be obtained for use in analysis include the following. Product title data can be obtained, such as length of product title, count of key words contained in the product title, and count of unique count of products referenced in the product title. Product description data can be obtained, such as count of words in the product description, count of key words on the product description, count of bullet points on the product description, and count of words in each bullet point, including statistical measures of these values such as average, median, variance, standard deviation, skewness, and kurtosis. Product image data can be obtained, such as count of images per product, size of the product images, product image background color, and pixel density and resolution of the product image. Product video data can be obtained, such as whether a product video is available, how many videos are available for the product, average length of product videos, and whether the product video has sound. Product star-rating data can be obtained, such as number and distribution of star ratings, and statistical variables derived from that distribution, such as average star rating (including a comparison of the average star rating to products linked from or linking to the product page), median star-rating, variance, skewness, and kurtosis of star rating. Brand data can be obtained, including the brand name associated with a particular product offered for sale, a count of the number of unique brands that offer a particular product for sale, and the length of associated brand names, including statistical measures of brand name length such as average, median, variance, standard deviation, skewness, and kurtosis. Product attribute data can be obtained, including shipping size, dimensions and weight; product size, dimensions and weight; count of unique products listed as compatible with the given product; count of words on the overall product page; availability of product dimension data; distance to the nearest warehouse where a product is stored; product purchase condition; best-seller status; availability of subscription options; and count of unique purchase channels through which a product can be purchased. Customer interaction data can be obtained, such as total number of customer comments; word count of customer comments, including statistical measures of comment length such as average, median, variance, standard deviation, skewness, and kurtosis; key word count in customer comments; time distribution of customer comments, including statistical measures of time distribution such as average, median, variance, standard deviation, skewness, and kurtosis; count of questions asked by customers about a product; helpfulness rating of customer answers; count of response for each question; type of customer providing feedback (e.g., whether the customer is a verified purchaser); rate of new customer interactions within a given timeframe, such as a second, a minute, an hour, a day, a week, a month, or a year; and time between purchase and writing of feedback. Search result data can be obtained based on searches of terms related to a product, such as a count of products in search results where the a product is featured; a count of search terms that return a product result; the ordered rank of the product in the search results, including changes in that order over time; the number of complementary products in the search results; the number of variations of the product in the search results; the number of supplementary products in the search results; and the number of search results related with a product. Catalog data can be obtained, such as overall catalog size for each electronic commerce website or API; the number of unique products in the website or API catalog; the number of new unique products in the website or API catalog in a given time frame, such as a second, a minute, an hour, a day, a week, a month, or a year; the number of unique products removed from the website or API catalog in a given time frame, such as a second, a minute, an hour, a day, a week, a month, or a year; the age of the product in the catalog; and the distribution of product ages in the catalog, including statistical measures of product age such as average, median, variance, standard deviation, skewness, and kurtosis. Advertisement data can be obtained, such as number of product advertisements available; length of time product advertisements have been available; unique count of impressions resulting from ads; conversion or click-through rates; keyword counts in each advertisement; overall advertisement word count; and mobile device push notification conversion rate. Product promotion data can be obtained, such as availability and percentage of product discounts and product bundling options. Market-based data can be obtained, such as a count of recommended products on the product webpage; a count of items where a product is listed as a recommended product; a count of products that are subsequently recommended on the recommended products listed on a product page; and a count of product recommended on similar products. The number of supplementary products on a product webpage can also be used as a variable. The price and price bracket of a product can be determined as input variables. Sales services provided for each product can be determined as input variables, including the availability of free shipping; the number of third party vendors of the product; customer interactions relating to third party vendors selling the product; availability and cost of gift wrapping services for the product; availability, cost, and length of warranty options for a product; delivery time for a product; and product delivery options, such as free delivery, same day, overnight, two-day, ground, air, or drone delivery. By accessing the catalogs of a plurality of electronic commerce websites or APIs, a total count of ecommerce merchants where the product is offered for sale can be determined for use as an input variable.

Graphs of related products, for example products in the “recommended products” section on a product's page, can obtained in which each product constitutes a node and links to other products on a given product's web page correspond to directional connections from the product to each related product. By analyzing a plurality of product pages and each page linked therefrom in a recursive manner, a graph can be generated, interconnecting all of a plurality of products in an electronic catalog of a website or API. Based on such graphs, clusters of related products can be determined; for example, by identifying a group of products in which each member of the group has a high probability of being linked to from each other member of the group, or wherein the group comprises a strongly connected component of the catalog graph or a subgraph thereof. A product can be within a plurality of different clusters, in which case the number of clusters to which the product belongs can be used as an input variable. Other variable inputs include a count of the number of product groups and product categories where a product belongs and the rank of a product within a given cluster of products. Products in a cluster can comprise competing products, and a count of the number of competing products in the cluster can be determined. A score can also be assigned to each product based on the number of other products linking to that product. This scoring system can score recursively as well; for example, by assigning a first score to each product based on the number of linking products, then computing a second score for each product, by assigning the second score based on both the number of linking products and the first score of each linking product linking to it. This process can be repeated multiple times; for example, until an equilibrium distribution of scores is reached.

Customer feedback such as reviews or likes can also be used to graph relationships among products. For example, if a given reviewer who has reviewed each of a plurality of products, this can indicate that the products are substitute or complimentary products. An undirected graph can be constructed among a plurality of products connected in this manner, and a connection strength for each vertex between products can be determined based on the number of users reviewing each, or the ratio of shared reviews to total reviews of the two products. Such a graph can then be analyzed to detect clusters of more strongly connected products, which can be used to identify a market, for example, as a set of products each likely to share reviewers with the others.

Additional data that can be obtained and used as input variables include: session metrics, such as count of total customers accessing a product page; breakdown based on whether such sessions resulted from ads; session length when visiting pages; session length for sales compared to sessions not resulting in sales; count of unique abandoned browse sessions where a product page was visited, including measures of central tendency such as mean, median, variance, skewness, kurtosis; number of purchases per page visit; number of purchases in a given time period; and purchase rates for all marketplace sellers of a product. Email marketing metrics can also be measured and used as input variables, for example, the number of emails sent to customers where a product is featured can be counted as a function of time; the number of customers targets in each email marketing campaign can be counted; the click-through rate of email campaigns where a product is featured can be measured; the conversion rate, meaning the likelihood of purchase given click-through, can be measured; the sales generated from email campaigns can be measured; and the customer returns resulting from items purchased through email campaigns can be measured. Each of these variables can also be converted into a statistical variable based on its respective distribution, such as an average, median, variance, standard deviation, skewness, and kurtosis of the variable.

Historical data related to a product can also be obtained, for example, by accessing past values of recorded variables and past estimates of sales information by sales estimation systems. For example, having previously generated sales estimates according to the processes disclosed herein, the sales estimation systems can treat those past estimates and the data used to generate them as historical data. Examples of historical data that can be used include historical unit sales of a product, including statistical measures thereof such as average, median, variance, standard deviation, skewness, and kurtosis; historical prices of a product, including statistical measures thereof such as average, median, variance, standard deviation, skewness, and kurtosis; historical sales value, margins and profits of a product, including statistical measures thereof such as average, median, variance, standard deviation, skewness, and kurtosis; historical product costs, including statistical measures thereof such as average, median, variance, standard deviation, skewness, and kurtosis; historical product order volume, including statistical measures thereof such as average, median, variance, standard deviation, skewness, and kurtosis; historical product return rate, including statistical measures thereof such as average, median, variance, standard deviation, skewness, and kurtosis; historical refund value, including statistical measures thereof such as average, median, variance, standard deviation, skewness, and kurtosis; historical count of unique customer purchases, including statistical measures thereof such as average, median, variance, standard deviation, skewness, and kurtosis; and time series of product data, including unit sales, prices, sales value, order volume, new customers, and customer returns, as well as statistical measures thereof such as average, median, variance, standard deviation, skewness, and kurtosis. A count of items in the shopping cart over a period of time can also be used as an input variable.

When acquiring data related to products, each product can be assigned a unique identifier, such as an SKU. However, in some aspects, identical products can be assigned to different SKU values; for example, if an electronic commerce website or API lists the same product on separate pages. In the course of acquiring product data, it is desirable to identify such “duplicate” products and reassign them to a single SKU. A pair of products can be compared by comparing a plurality of input variables for each, such as product name, weight, dimensions, image parameters, and price, and assigning a similarity score that increases for values of each variable that match exactly or approximately. Further comparisons can be made based on related product graphs; for example, two products can be judged to be similar if they have similar “recommended products” on their product pages, or if many other product pages list both as “recommended products,” and a similarity score can be adjusted based on the degree of similarity in this regard. After determining a similarity score, two products can be judged to be similar if their similarity score exceeds a predetermined threshold. Products so determined can then be reassigned to a single SKU, representing a sum of the two products. This process can be iterated until all duplicate products have been assigned unique identifiers.

When product data of different types are obtained over different timescales, they can be adjusted, such as by averaging or interpolation, to cover different timescales as needed.

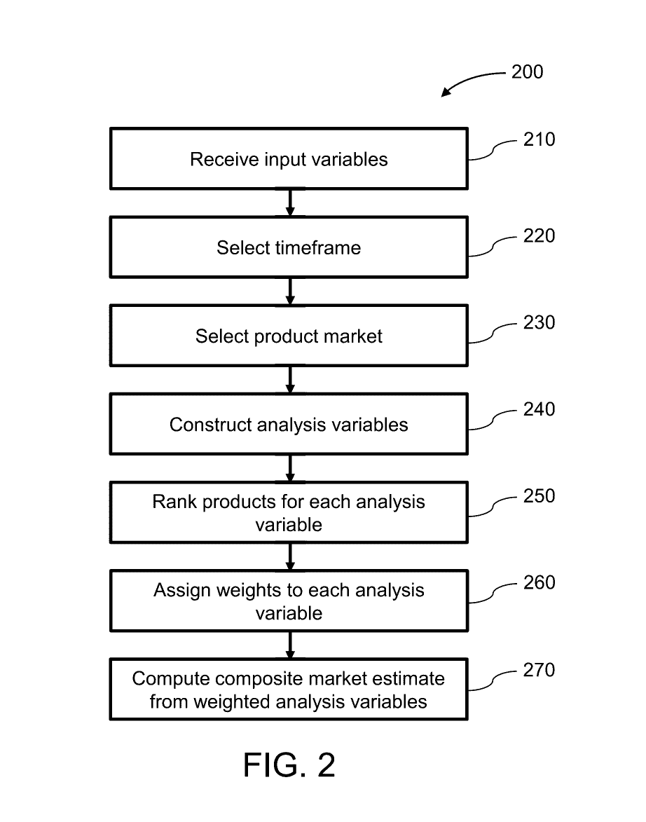

After acquiring a plurality of input variables as disclosed above for each of a plurality of products within a market, these variables can be analyzed by the sales estimation systems to determine sales estimates for each of a plurality of products. FIG. 2 illustrates a process 200 of generating sales estimates for one or more products in an online marketplace, in accordance with embodiments. The process 200 can be performed by the sales estimation systems, for example, by executing a set of instructions stored in memory, the instructions being executable by a processor to cause each step of the method to be performed.

In step 210 input variables are obtained. The input variables can be obtained from a plurality of electronic commerce websites or APIs, as described above. Alternatively or additionally, the input variables can be read from memory associated with the sales estimation systems; for example, the data can be historical data, past estimates generated by the sales estimation systems, user-supplied data, and/or data recorded from a search using the methods for obtaining electronic commerce data described above.

In step 220, a timeframe is selected over which to perform analysis. This timeframe can be selected by user input; for example, a database query from user 106. Alternately, the method can be performed for one or more of a set of typical time frames, such as a day, a week, a month, a season, or a year.

In step 230, a product market is selected. This selection can be made by choosing from among a set of enumerated markets, or by choosing a product and determining related products which form a market, for example, using the graphical methods described above. The product market comprises a plurality of products. The market can also be subdivided or grown; for example, by removing products less closely related to the remaining products to shrink the market, or adding the next most closely related products to grow it.

In step 240, a plurality of analysis variables is constructed based on the input variables and the timeframe. Each analysis variable can be defined as a function of one or more input variables. For example, an input variable can, on its own, be an analysis variable. An analysis variable can also be formed as the product of one or more input variables, or as powers or roots thereof, such as squares, cubes, square roots, or cube roots. An analysis variable can also be constructed from a distribution of an input variable over the chosen timeframe, such as an average slope, curvature, or higher-order derivative, or as a statistical property of an input variable over the chosen timeframe such as an average, median, variance, standard deviation, skewness, and kurtosis. Each analysis variable produces a value for each product in the market, and a normalized analysis variable can generated for each analysis variable by multiplying by a constant, such that each analysis variable sums to 1 for a given market. The functions chosen to determine an analysis variable are chosen such that the resulting value of the analysis variable for each product will be proportional to the sales volume of that product; equivalently, a normalized analysis variable will be proportional to market share.

For example, a set of analysis variables can be constructed using the following sub-steps: first, an initial set of analysis variables is created, wherein each analysis variable in the initial set is an input variable of the plurality of input variables. Equivalently, each analysis variable in the initial set of analysis variables can be described as equal to an identity operator times an input variable. Next, a new analysis variable can be created from the set of analysis variables, in conjunction with a set of operators.

The set of operators each takes one or more variables as inputs and give a variable as an output. Examples of operators that can be chosen are a multiplication operator, which takes two analysis variables A and B and outputs the product A*B; a square root operator, which takes one analysis variable A and outputs \sqrt{A}; a constant multiplier, which takes one analysis variable A and outputs k*A for a constant k; an addition operator, which takes two analysis variables A and B and outputs the sum A+B; an exponential operator, which takes two analysis variables A and Band outputs A^{B}; a division operator, which takes two analysis variables A and B and outputs the quotient A/B; a time derivative operator, which takes one analysis variable A, which is a function of time over a given time frame, and outputs the time derivative of A over that time frame; and a statistical operator, which takes one analysis variable A as input and outputs a chosen one of mean, variance, skewness, or kurtosis of A over a time frame.

A new analysis variable is added to the set of analysis variables by choosing an operator from the set of operators, then choosing one or more analysis variables from the set of analysis variables to serve as inputs for the operator. Thus, a set of N analysis variables is augmented to be a set of N+1 analysis variables. This process of adding a new analysis variable can be repeated to keep adding analysis variables until reaching a predetermined number of analysis variables. This process can also be repeated in response to a determination in steps 260 and 270 that the overall fit generated based on a set of analysis variables leaves too large of a residual error when compared to fitting data. In this way, additional analysis variables can be added to a set based on a need to increase fitting accuracy.

Each analysis variable can thus be described as a combination of one or more input variables and one or more operators. For example, an analysis variable can be formed from a combination of a total quantity of reviews, a net increase in reviews over an identified time period, and a product rating score. This combination can be created using one or more operators; for example, the analysis variable can be equal to the product of the three input variables (which can be expressed as a product of one input variable with the product of the other two). Alternatively, the combination can be a geometric mean of the three input variables, which would be given by the cube root of their product. Other combinations include a combination of a frequency of product appearance for keyword searches with a rank position of products in response to keyword searches—for example, a product or geometric mean of these two input variables—and an analysis variable equal to a score generated from a graph of related or recommended products, wherein the input variable has a value for each product equal to the number of products recommending that product (or alternatively, a score generated by initially scoring each product in this way, then repeating such a scoring, with the score of each product determined by a weighted sum of products recommending or related to the product, wherein the weightings are determined from each product's score in an iterative or self-consistent manner).

The set of analysis variables can also comprise one or more previously used analysis variables. For example, if previous fittings using this method assigned a high weight to a certain set of analysis variables, those analysis variables can be identified and added to the set of analysis variables. Previously successful variable combinations can thus be maintained for use in future sales value estimates. In some aspects, a particular set of very successful analysis variables can be determined, and these analysis variables can be used alone to estimate sales values, or be used in combination with a pool of candidate analysis variables generated as described above, to allow adjustments to be made to the analysis variable set over time.

In step 250, the set of products is assigned a rank order for each analysis variable, from largest to smallest. With the products so ordered, the corresponding normalized analysis variable ordering acts as an estimate of market share, product by product, ordered from largest to smallest. Such an ordering can, for example, be used to generate market volume (for analysis variables) or market share (for normalized analysis variables) as a function of rank-ordered product number. However, since each analysis variable can be independent of each other analysis variable, their respective relationships can differ. Similarly, the ordering of the products can vary between analysis variable. Each analysis variable can then act as an initial estimate of a product value, such as product sales volume or product sales revenue.

In step 260, weighting coefficients are assigned to each analysis variable, based on a comparison of their values for each product, with historic estimates of the same market, and with externally-sourced product data. The weighting coefficients can be normalized by making their sum over their respective analysis variables equal to 1. For each pair of analysis variables, a distance function can be applied to determine an overall degree of difference in their product value estimates. For example, for a pair normalized analysis variables, an absolute difference in value can be calculated for each product, and these differences can be summed to compute a total integrated absolute difference. Alternatively, the differences between variables can be summed in quadrature. In some aspects, when a pair of variables orders products differently, a further difference can be computed based on the number of inversions in their rank order, and this difference can be added to or multiplied by a difference computed based on a value-based distance function. By calculating the distance between each pair of analysis variables, a statistical similarity between variables can be determined, based upon which more closely clustered variables can be weighted more heavily while outliers can be weighted less strongly. Variables can also be compared to historical estimates computed for the same market, using past estimates of quantities such as sales volume and market share for the same or a similar set of products in the market. Variables that more closely match historical data are then weighted more heavily, with more weight given to comparisons with historical data that are closer in time. In some aspects, seasonal adjustments can be made; for example, similarity to historical product value estimates can be weighted more strongly for estimates a year earlier than a month earlier. Adjustments for trends can also be made; for example, an expected market volume can be calculated based on a linear or higher-order extrapolation of past market volume. Further weighting can be performed based on user-provided market data, such as sales data for certain selected products in the identified market. This data can be received, for example, from user 106, and can represent real sales figures for a plurality of the user's products. Each analysis variable can be compared to the user-provided market data to determine an modeling accuracy, and a score can be assigned based on a difference function, such as a least-squares fit residual. Because the user-provided market data often represent sales, instead of market share, an additional free parameter can be applied as a fit multiplier to each analysis variable. This parameter serves to convert the units of the analysis variable to the units of the user-provided market data, such as number of units sold, or total product revenue, thereby allowing the parameter-adjusted analysis variable to act as a sales volume or sales revenue estimate. At the same time, fitting based on user-provided market data provides a clear, real-world link, enabling a differentiation between analysis variables based on how accurately they model real sales values. This is of particular value when historical data are sparse or unreliable, and allows sales estimates to be adjusted to otherwise unanticipated changes in a market.

In step 270, a composite market estimate is computed based on the weighting coefficients and fit parameters of step 260. For example, each of the plurality of analysis variables can be multiplied by its respective weighting coefficients and fit parameters as determined in step 260, then summed to generate composite estimates. These relationships represent final, composite market estimates in the form of an assignment of an economic quantity such as market share, sales volume, or sales revenue to each product in the identified market. These data can, for example, be presented to a user in graphical or numerical format. In some aspects, the user can be given access to the full set of individualized estimates. Furthermore, the user can be provided with such estimates for each of a plurality of markets and a plurality of time scales, by providing the results from a plurality of iterations of process 200.

As will be apparent to one of ordinary skill in the art, steps 260 and 270 accomplish in combination the process of combining a plurality of weighted variables into composite estimates, while adjusting their respective weighting coefficients to minimize a computed error function. The minimized error function comprises an overall difference calculation as described above, which can, for example, comprise error terms based on differences between the composite estimates and historical data as well as user-provided market data. Accordingly, in some embodiments, this minimization can be accomplished as a single combined step; for example, by treating the weighting parameters as minimization variables. In some aspects, the minimization procedure can be computed numerically using an iterative process, such as a Monte Carlo minimization.

A plurality of market share estimates, each corresponding to one or more different variables, can be combined using a small number of representative sales data to generate calibrated sales estimates for a market. In some embodiments, comparisons of a rank ordering of a plurality of products in a chosen market to sales of that product can be generated. Generating estimates without weighting would produce an estimate with significant disagreement with the data. For example, applying an error function comparing the data and estimates can produce a large residual error, indicating a poor fit to the data. This fit can be improved by applying different weighting coefficients to each of the analysis variables, based on their respective error scores. In some aspects, poorly-fitting variables can be removed altogether, allowing future iterations of a weighting function to proceed more quickly. Eliminating a variable can equivalently be accomplished by setting its weighting coefficient to 0. After determining the weighting coefficients for each analysis variable, weighted composite estimates are generated. The composite estimates fit the data more closely than either the unweighted estimates or any of the analysis variable estimates. The composite estimates can also represent, for example, an estimate of total sales volume for each of the products in the identified market. Similar calculations can be done using product sales data to generate an estimate of product-by-product revenue. Alternatively or additionally, revenue value relationships can be generated from volume value relationships by multiplying each product by its price (or average price), determined based on the price input variable disclosed above. Equivalently, volume value relationships can be generated from revenue value relationships by dividing each product's revenue by its price. Each set of revenue and volume estimates can be normalized to generate a measure of market share by revenue or volume, respectively.

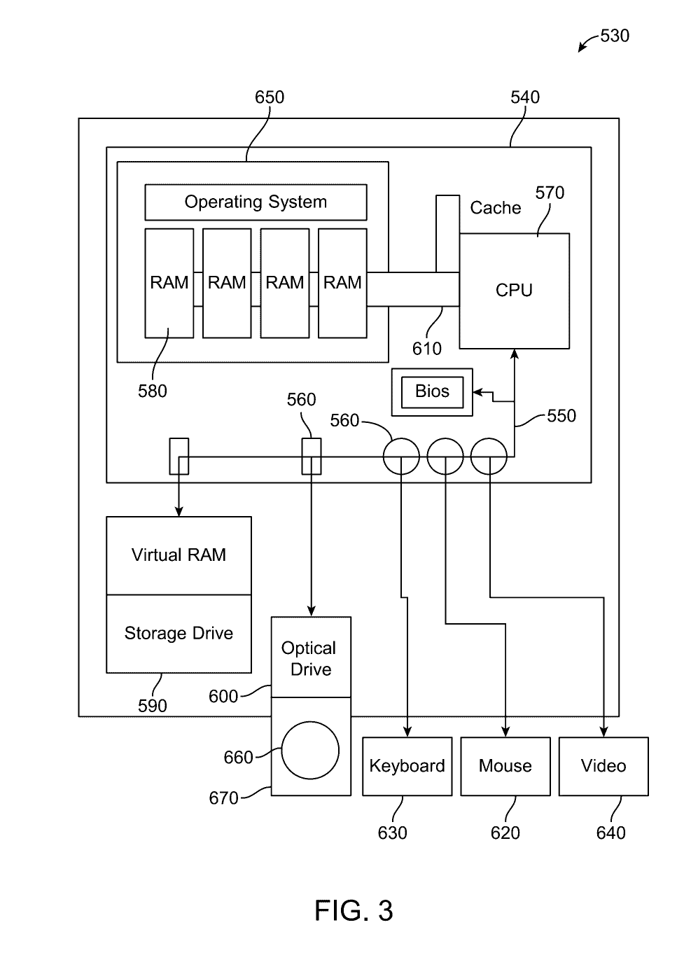

As described in detail herein, sales estimation systems and methods can be implemented on a computer system. For example, FIG. 3 illustrates a high level block diagram of an exemplary computer system 530 which can be used to perform embodiments of the processes disclosed herein, including but not limited to process 200. It can be appreciated that in some embodiments, the system performing the processes herein can include some or all of the computer system 530. In some embodiments, the computer system 530 can be linked to or otherwise associated with other computer systems 530, including those in the networked system 100, such as via a network interface (not shown). In an embodiment the computer system 530 has a case enclosing a main board 540. The main board has a system bus 550, connection ports 560, a processing unit, such as Central Processing Unit (CPU) 570, and a data storage device, such as main memory 580, storage drive 590, and optical drive 600. Each of main memory 580, storage drive 590, and optical drive 600 can be of any appropriate construction or configuration. For example, in some embodiments storage drive 590 can comprise a spinning hard disk drive, or can comprise a solid-state drive. Additionally, optical drive 600 can comprise a CD drive, a DVD drive, a Blu-ray drive, or any other appropriate optical medium.

Memory bus 610 couples main memory 580 to CPU 570. The system bus 550 couples storage drive 590, optical drive 600, and connection ports 560 to CPU 570. Multiple input devices can be provided, such as for example a mouse 620 and keyboard 630. Multiple output devices can also be provided, such as for example a video monitor 640 and a printer (not shown). In an embodiment, such output devices can be configured to display information regarding the processes disclosed herein, including but not limited to a graphical user interface facilitating the file transfers, as described in greater detail below. It can be appreciated that the input devices and output devices can alternatively be local to the computer system 530, or can be located remotely (e.g., interfacing with the computer system 530 through a network or other remote connection).

Computer system 530 can be a commercially available system, or can be proprietary design. In some embodiments, the computer system 530 can be a desktop workstation unit, and can be provided by any appropriate computer system provider. In some embodiments, computer system 530 comprise a networked computer system, wherein memory storage components such as storage drive 590, additional CPUs 570 and output devices such as printers are provided by physically separate computer systems commonly tied together in the network (e.g., through portions of the networked system 100). Those skilled in the art will understand and appreciate the physical composition of components and component interconnections comprising computer system 530, and select a computer system 530 suitable for performing the methods disclosed herein.

When computer system 530 is activated, preferably an operating system 650 will load into main memory 580 as part of the boot sequence, and ready the computer system 530 for operation. At the simplest level, and in the most general sense, the tasks of an operating system fall into specific categories—process management, device management (including application and user interface management) and memory management.

In such a computer system 530, the CPU 570 is operable to perform one or more methods of the systems, platforms, components, or modules described herein. Those skilled in the art will understand that a computer-readable medium 660, on which is a computer program 670 for performing the methods disclosed herein, can be provided to the computer system 530. The form of the medium 660 and language of the program 670 are understood to be appropriate for computer system 530. Utilizing the memory stores, such as one or more storage drives 590 and main system memory 580, the operable CPU 570 will read the instructions provided by the computer program 670 and operate to perform the methods disclosed herein.

Accordingly, in an embodiment the CPU 570 (either alone or in conjunction with additional CPUs 570) therein, which can be configured to perform the processes described herein. In an embodiment the CPU 570 can be configured to execute one or more computer program modules, each configured to perform one or more functions of the systems, platforms, components, or modules described herein. It can be appreciated that in an embodiment, one or more of the computer program modules can be configured to transmit, for viewing on an electronic display such as the video monitor 640 communicatively linked with the CPU 570, a graphical user interface (which can be interacted with using the mouse 620 and/or keyboard 630).

In the processes disclosed herein, a process can comprises performing any of the methods disclosed herein. In the processes disclosed herein, a process can comprise using any of the systems disclosed herein. In the methods disclosed herein, a method can comprise using any of the systems disclosed herein. In the systems disclosed herein, a system can be used to perform any of the methods or processes disclosed herein.

As used herein, where the indefinite article “a” or “an” is used with respect to a statement or description of the presence of a step in a process disclosed herein, unless the statement or description explicitly provides to the contrary, the use of such indefinite article does not limit the presence of the step in the process to one in number. In this specification and the appended claims, the singular forms “a,” “an” and “the” include plural reference unless the context clearly dictates otherwise. As used herein, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed.

Where a range of numerical values is recited herein, unless otherwise stated, the range is intended to include the endpoints thereof, and all integers and fractions within the range. It is not intended that the scope of the invention be limited to the specific values recited when defining a range.

As used herein, the terms “comprises,” “comprising,” “includes,” “including,” “has,” “having,” “contains,” or “containing,” or any other variation thereof, are intended to cover a nonexclusive inclusion. For example, a composition, a mixture, process, method, article, or apparatus that comprises a list of elements is not limited to only those elements but can include other elements not expressly listed or inherent to such composition, mixture, process, method, article, or apparatus. Further, unless expressly stated to the contrary, “or” refers to an inclusive or and not to an exclusive or.

As used herein, the term “about” refers to variation in the reported numerical quantity that can occur. The term “about” means within 10, 9, 8, 7, 6, 5, 4, 3, 2, or 1% of the reported numerical value.

Unless otherwise specified, the presently described methods and processes can be performed in any order. For example, a method describing steps (a), (b), and (c) can be performed with step (a) first, followed by step (b), and then step (c). Or, the method can be performed in a different order such as, for example, with step (b) first followed by step (c) and then step (a). Furthermore, those steps can be performed simultaneously or separately unless otherwise specified with particularity.

While preferred embodiments of the present disclosure have been shown and described herein, it is to be understood that the disclosure is not limited to the particular embodiments of the disclosure described below, as variations of the particular embodiments can be made and still fall within the scope of the appended claims. It is also to be understood that the terminology employed is for the purpose of describing particular embodiments of the disclosure, and is not intended to be limiting. Instead, the scope of the present disclosure is established by the appended claims.

What is claimed is:

1. A method of estimating a sales value, the method comprising:
obtaining, with a computer, content from product pages for products in at least one online catalog;
generating, with the computer, a graph comprising a plurality of vertices and a plurality of edges, wherein each vertex in the plurality of vertices corresponds to a product, wherein each edge in the plurality of edges connects a pair of vertices, and wherein the edges are determined by the content obtained from the product pages corresponding to one or more of the pair of vertices;
determining, with the computer, a market derived from the graph, wherein the market comprises a plurality of products;
assigning, with the computer, to each input variable of a plurality of input variables a corresponding value for each product in the market, wherein the corresponding value is derived from the content obtained from the product pages;
defining, with the computer, a plurality of analysis variables derived from the input variables, wherein the analysis variables have a value derived from the input variables for each product in the market;
assigning, with the computer, weights to each analysis variable in the plurality of analysis variables;
generating, with the computer, an estimate of a sales value for at least one product in the market, wherein the estimate is determined from a weighted sum of the analysis variables; and
recording, to a computer-readable medium, information representing the estimate.

2. The method of claim 1, wherein the weights are assigned to each analysis variable based on a fit of each analysis variable to input data for at least one product in the market, and wherein the input data for the at least one product comprises past estimates of sales values, user-supplied measures of sales values, or a combination of the two.

3. The method of claim 1, wherein the estimate of the sales value corresponds to a specified period of time.

4. The method of claim 3, wherein the sales value is product market share, product revenue, or product sales volume.

5. The method of claim 1, wherein obtaining, with the computer, the content of the plurality of product pages comprises:
entering into a website or API a search term related to a market of interest;
appending a plurality of product pages generated in response to the search to a list of pages to visit;
visiting a page on the list of pages to visit that has not yet been visited;
parsing the page to obtain content therefrom;
identifying, from the parsed content, one or more linked product pages;
adding to the list of pages to visit each linked product page identified that has not already been added; and
repeating the steps of visiting, parsing, identifying, and adding until either reaching a predetermined threshold of visited pages or determining that each product page on the list of pages to visit has been visited.

6. The method of claim 1, wherein one or more of the plurality of input variables comprise a product price, a product ranking by retailers, a number of customer reviews for products, a score from a product search query ranking order, or a score based on the number of products identifying each product as related or recommended.

7. The method of claim 1, wherein a first input variable of the plurality of input variables has a value for each product derived from the graph, and wherein each edge of the graph leading from a first product to a second product corresponds to a listing of the second product as a related or recommend product on a product page of the first product.

8. The method of claim 7, wherein the value of the first input variable for each product is equal to a score determined by:
assigning to each product an initial score; and
updating the score of each product according to the scores of each other product with an edge leading thereto.

9. The method of claim 8, further comprising repeating the step of updating for a fixed number of times or repeating the step of updating until the score for each product changes less than a predetermined threshold in a given iteration.

10. The method of claim 1, wherein the plurality of analysis variables are derived from the input variables by:
initializing a set of analysis variables containing each input variable of the plurality of input variables;
selecting an operator from a set of operators, the operator having one or more inputs;
creating a new analysis variable by selecting, for each input of the operator, a previous analysis variable in the set of analysis variables;
adding the new analysis variable to the set of analysis variables; and
repeating the steps of selecting an operator, creating a new analysis variable, and adding the new analysis variable to the set of analysis variables until the size of the number of analysis variables in the set of analysis variables reaches a predetermined threshold.

11. The method of claim 10, further comprising:
identifying, from a plurality of analysis variables previously used to fit sales data, one or more previously used analysis variables to which highest weights were assigned, and adding the one or more previously used analysis variables to the set of analysis variables.

12. The method of claim 1, wherein at least one analysis variables is derived from a combination of input variables including a total quantity of reviews, a net increase in reviews over the identified time period, and a product rating score.

13. The method of claim 1, wherein at least one analysis variables is derived from a combination of input variables including a frequency of product appearance for keyword searches and a rank position of products in response to keyword searches.

14. The method of claim 1, wherein the step of generating an estimate of a sales value is performed for every product in the market.

15. The method of claim 14, further comprising estimating a total market size for the sales value.

16. A system for estimating sales values, comprising:
a processor coupled to a computer network;
a computer-readable storage medium; and
non-transient computer-readable memory coupled to the processor, the memory comprising instructions that, when executed, cause the system to:
obtain content from product pages for products in at least one online catalog;
generate a graph comprising a plurality of vertices and a plurality of edges, wherein each vertex in the plurality of vertices corresponds to a product, wherein each edge in the plurality of edges connects a pair of vertices, and wherein the edges are determined by the content obtained from the product pages corresponding to one or more of the pair of vertices;
determine a market derived from the graph, wherein the market comprises a plurality of products;
assign to each input variable of a plurality of input variables a corresponding value for each product in the market, wherein the corresponding value is derived from the content obtained from the product pages;
define a plurality of analysis variables derived from the input variables, wherein the analysis variables have a value derived from the input variables for each product in the market;
assign weights to each analysis variable in the plurality of analysis variables;
generate an estimate of a sales value for at least one product in the market, wherein the estimate is determined from a weighted sum of the analysis variables; and
record information representing the estimate to the computer-readable storage medium.

17. The system of claim 16, wherein the weights are assigned to each analysis variable based on a fit of each analysis variable to input data for at least one product in the market, wherein the input data for the at least one product comprises past estimates of sales values, user-supplied measures of sales values, or a combination of the two.

18. The system of claim 16, wherein the estimate of the sales value corresponds to a specified period of time.

19. The system of claim 18, wherein the sales value is product market share, product revenue, or product sales volume.

20. The system of claim 16, wherein the instructions to obtain the content of the plurality of product pages comprise instructions to:
enter into a website or API a search term related to a market of interest;
append a plurality of product pages generated in response to the search to a list of pages to visit;
visit a page on the list of pages to visit that has not yet been visited;
parse the page to obtain content therefrom;
identify, from the parsed content, one or more linked product pages;
add to the list of pages to visit each linked product page identified in step e) that has not already been added; and
repeat the steps visit, parse, identify, and add steps until either reaching a predetermined threshold of visited pages or determining that each product page on the list of pages to visit has been visited.

21. The system of claim 16, wherein one or more of the plurality of input variables comprise a product price, a product ranking by retailers, a number of customer reviews for products, a score from a product search query ranking order, or a score based on the number of products identifying each product as related or recommended.

22. The system of claim 16, wherein a first input variable of the plurality of input variables has a value for each product derived from the graph, and wherein each edge of the graph leading from a first product to a second product corresponds to a listing of the second product as a related or recommend product on a product page of the first product.

23. The system of claim 22, wherein the value of the first input variable for each product is equal to a score, and wherein the instructions include instructions to:
assign to each product an initial score; and
update the score of each product according to the scores of each other product with an edge leading thereto.

24. The system of claim 23, further comprising instructions to repeat the updating for a fixed number of times or repeating the step of updating until the score for each product changes less than a predetermined threshold in a given iteration.

25. The system of claim 16, wherein the system is configured to derive the plurality of analysis variables from the input variables by:
initializing a set of analysis variables containing each input variable of the plurality of input variables;
selecting an operator from a set of operators, the operator having one or more inputs;
creating a new analysis variable by selecting, for each input of the operator, a previous analysis variable in the set of analysis variables;
adding the new analysis variable to the set of analysis variables; and
repeating the steps of selecting an operator, creating a new analysis variable, and adding the new analysis variable to the set of analysis variables until the size of the number of analysis variables in the set of analysis variables reaches a predetermined threshold.

26. The system of claim 25, wherein the system is further configured to:
identify, from a plurality of analysis variables previously used to fit sales data, one or more previously used analysis variables to which highest weights were assigned, and add the one or more previously used analysis variables to the set of analysis variables.

27. The system of claim 16, wherein at least one analysis variables is derived from a combination of input variables including a total quantity of reviews, a net increase in reviews over the identified time period, and a product rating score.

28. The system of claim 16, wherein at least one analysis variables is derived from a combination of input variables including a frequency of product appearance for keyword searches and a rank position of products in response to keyword searches.

29. The system of claim 16, further comprising instructions to generate an estimate of a sales value for every product in the market.

30. The system of claim 29, further comprising instructions to estimate a total market size for the sales value.
